(19) United States
(12) Patent Application Publication
(10) Pub. No.: US 2008/0150716 A1
(43) Pub. Date: Jun. 26, 2008

(54) Remote Monitoring Device

(76) Inventor: Marc Huang, Shintien City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/868,642

(22) Filed: Oct. 8, 2007

(30) Foreign Application Priority Data
Dec. 20, 2006 (TW) 95222416

(51) Int. Cl. G08B 21/00

(52) U.S. Cl. 340/540

(57) ABSTRACT

A remote monitoring device comprising an illuminating device, an image capturing device, a sensing device, and a loudspeaker is provided. When the sensing device senses a change in the surrounding environment, the illuminating device lights up, the image capturing device generates image signals, and the loudspeaker activates.

This application claims the benefits of the priority based on Taiwan Patent Application No. 095222416 filed on Dec. 20, 2006; the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a remote monitoring device. In particular, the invention relates to a remote monitoring device that is adapted to sense variations in the surroundings, emit sounds, and record images.

2. Descriptions of the Related Art

With the advancement of imaging technology, users nowadays can utilize remote monitoring devices to monitor the state of a remote location. For example, remote monitoring devices may be used by security guards to monitor various floors of a building, by express railway clerks to monitor the interior of railway cars, by parents at work to monitor children or housekeepers at home, by home owners to monitor the outside of the house, and so on. By means of remote monitoring devices and technologies, the user can be informed of the state of a remote place without the need for personal presence at the monitored site. If necessary, the user may even simultaneously monitor a plurality of locations to improve monitoring efficiency.

A door access control system will be used as an example, since various monitoring systems are now employed in these types of access systems. For example, a conventional door access control system is passively activated by a visitor, and only when the visitor presses a call button can the door system start its operation, acting as a means of remote communication between the home owner and the visitor. Additionally, the system may record images of the visitor to act as a visual aid for the home owner. However, this system suffers from a disadvantage in that some people can deliberately evade the passive monitoring system.

Another conventional monitoring system utilizes cameras installed in buildings, which work continuously for a prolonged time to record and store images for investigation and review. The problem with this system is that a sufficient amount of storage space has to be allocated for such a large number of images, and numerous irrelevant images contained therein not only unnecessarily consume power, but also necessitate image filtering in order to obtain critical information. Moreover, because an excessive number of images are recorded, image quality tends to be compromised in favor of a longer recording time, and image data is subject to compression loss due to insufficient storage space, leading to both low efficiency and poor convenience.

There is still another type of alarm system available in the market that, upon an object's approach to the door access system, operates to turn on an illuminating device to alarm or frighten the subject. However, this type of system only provides an alarm function, which is inadequate for a door access system.

In view of this, it is highly desired in the art to provide a remote monitoring device possessing a multitude of functions in order to provide a complete protection system under a given situation.

### SUMMARY OF THE INVENTION

The primary objective of this invention is to provide a remote monitoring device with illuminating, sensing, and sound emitting functions integrated therein in order to detect any variation of the surrounding environment at the earliest possible time. In response to this detection, the system will immediately give an alarming or welcoming sound, so as to prevent any further intrusion or possible invasion.

Another objective of this invention is to provide a remote monitoring device that is configured to remotely monitor or pre-record variations of the surrounding environment for investigation and evidence collection afterwards.

Yet a further objective of this invention is to provide a remote monitoring device possessing an active monitoring function, which can activate an illuminating device and record images simultaneously once a variation is detected within the surrounding environment. In this way, the amount of image data to be recorded is reduced substantially, thereby improving the overall efficacy of the image data.

Still a further objective of this invention is to provide a remote monitoring device, which may comprise a storage medium disposed therein to store image data, or transmit data through a network device and an internet protocol (IP) for image data storage in a remote host device, so that the data storage capacity is increased significantly.

To achieve the abovementioned objectives, the remote monitoring device of this invention comprises a body, an illuminating device, an image capturing device, a sensing device, and a loudspeaker. The illuminating device is configured to provide an indicating light source, the image capturing device is configured to capture an image and generate an image signal, the sensing device is electrically connected with the illuminating device and the image capturing device, and the loudspeaker is electrically connected with the sensing device. Together, the illuminating device and the image capturing device are activated to generate the image signal, and the loudspeaker is activated to sound once the sensing device senses a change in the environment surrounding the monitoring device.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a perspective schematic view illustrating the remote monitoring device of the present invention; and

FIG. 2 is a block diagram illustrating the systematic architecture of the remote monitoring device of the present invention.

### DESCRIPTION OF THE PREFERRED EMBODIMENT

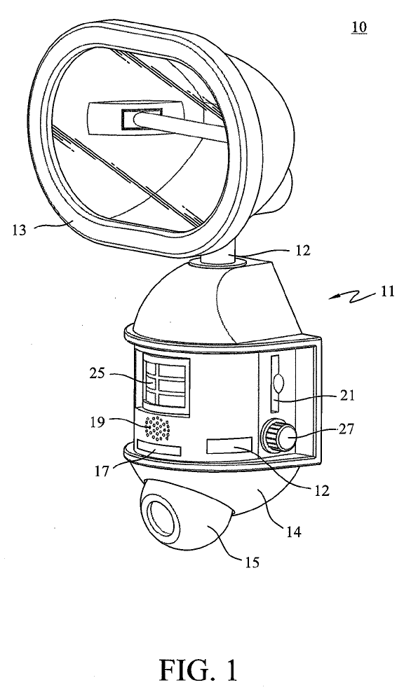

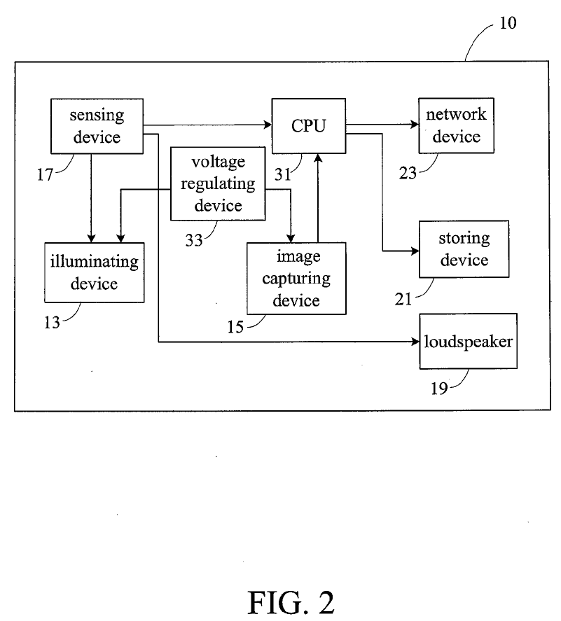

Referring to FIG. 1 and FIG. 2, FIG. 1 depicts a perspective view of a monitoring device 10 of the present invention, and FIG. 2 depicts a basic block diagram of connections in the system.

The monitoring device 10 of the present invention comprises a body 11, and an illuminating device 13, an image capturing device 15, a sensing device 17, and a loudspeaker 19 disposed on the body 11. The sensing device 17 is electrically connected with the illuminating device 13 and the image capturing device 15, and the loudspeaker 19 is electrically connected with the sensing device 17. The illuminating device 13 has at least one lamp disposed therein to provide an indicating light source during the operation of the monitoring device 10.

Preferably, the sensing device 17 is a motion sensor, such as a private infrared ray (PIR) sensor, which can be triggered by a variation of an image of the surrounding environment. When the sensing device 17 senses that the environment surrounding the monitoring device 10 is different, for example, when a visitor or a stranger approaches, the monitoring device 10 is activated. Then, the image capturing device 15 proceeds to capture an image of the surroundings around the monitoring device 10 and generates an image signal. Preferably, the illuminating device 13 is simultaneously turned on to increase brightness of the surroundings, which will not only help to obtain a better image capturing effect, but also serve an alarming function. Meanwhile, the image capturing device 15 may be adjusted to a particular capturing frequency, for example, at least 5 image signals per second, so that these image signals can be combined into dynamic image sequences. By combining the illuminating device 13 and the image capturing device 15, a higher luminance can be taken in the resulting image signals. All these can help improve the quality of the image signals generated by the image capturing device 15. Additionally, the loudspeaker 19 may also be activated simultaneously to give a sound, such as an appropriate alarming sound, a piece of music, a greeting sound, or a pre-recorded sound inquiring the visitor's status.

The sensing device 17 may be provided with various adjusting functions to facilitate its use under different environment conditions, for example, under various lighting conditions; or, it may have a settable sensitivity, so that the sensing range can be adjusted.

These image signals may need to be stored for an appropriate time period for subsequent review by the user. Therefore, a storage device 21 may further be disposed on the body 11 of the monitoring device 10. The storage device 21 is a storage medium adapted to store these image signals. For example, the storage medium may be, but is not limited to, a readable and rewritable device such as an SD (secure digital memory) card, a Mini SD card, a Micro SD card, a CF (compact flash) card, or a hard disk, so that the image signals stored therein can be recalled and read at any time.

A network device 23 may be further provided on the body 11 of the monitoring device 10 to transmit the image signals through a wired or wireless network, such as the Internet or a local area network. Through use of the networking device 23, a remote user may utilize a terminal device (e.g., a personal computer, a PDA, a mobile communication device, and etc.) to access a server system through the Internet and connect with the monitoring device 10 to receive image signals and/or sound signals therefrom. Thus, the user can be informed of the real-time state of the surroundings around the illuminating device 13 for the purpose of remote monitoring. Further, the monitoring device 10 may store the image signals into a host device through the network device 23, for example by use of a USB or a wireless transmitting device, in order to avoid the problem of insufficient storage capacity of the storage device 21. In this case, as a host device is typically equipped with greater storage ability, the storage device 21 that is equipped in the monitoring device 10 does not need to have an unnecessarily large capacity, thus facilitating in a further reduction in size of the monitoring device 10.

The network device 23 can further enable the remote user to transmit/receive an audio signal in response to the state of the surroundings around the monitoring device 10, for example, to talk with a visitor. In this case, an audio receiving/transmitting device 25 (e.g., a microphone/loudspeaker) is needed to connect with the networking device 23, in order to transmit an audio signal to and receive an audio signal from a designated network. The audio receiving/transmitting device 25 may have an audio transmitting component implemented by the loudspeaker 19 or implemented separately. In this way, with a combination of the image signals and the audio signals, the user can have a clear picture of the real-time state of the surroundings around the illuminating device 13, and can also remotely transmit/receive an audio signal.

The monitoring device 10 may further comprise an adjustment mechanism 14 connected between the body 11 and the image capturing device 15 to adjust the image capturing angle of the image capturing device 15. The user can obtain a preferred monitoring angle by adjusting the adjustment mechanism 14. In addition to the image capturing device 15, an adjustment mechanism 12 may also be connected between the illuminating device 13 and the body 11 to yield a preferred illuminating angle, and will not be further described herein.

The remote monitoring device 10 disclosed in the present invention may further comprise an automatic timer switch 27, which is disposed on the body 11 and electrically connected with the illuminating device 13, and the image capturing device 15 for controlling the two to work within a desired period of time, so that the illuminating device 13 and the image capturing device 15 can be turned on and off in response to lighting conditions to fulfill the monitoring requirements given the situation, and to reduce power consumption.

To clearly disclose this invention, a visitor camera for a door access system is taken as an example in the above description to describe the image capturing device 15, but this invention is not limited thereto.

It shall be appreciated that, in the remote monitoring device 10 of the present invention, a power supply (not shown) is required to operate all the devices. Referring to FIG. 2, in order to stably operate the abovementioned devices, a central processing unit (CPU) 31 may be further equipped to control the operation of the sensing device 17 and process the images captured by the image capturing device 15, so that the images can be combined into dynamic images and be stored or transmitted; alternatively, the CPU 31 may also be configured to control the operational time of the illuminating device 13, to temporarily turn off the storing function of the storage device 21, and so on.

The remote monitoring device 10 may further comprise a voltage regulating device 33 that is disposed between the illuminating device 13 and the image capturing device 15 to provide them with the desired voltages, respectively. More specifically, the illuminating device 13 is driven by a first voltage and the image capturing device 15 is driven by a second voltage. In case that the first voltage (e.g., the common 110 volts AC) is not the same as the second voltage (e.g., the common 12 volts DC), and a single power supply is intended to be employed (e.g., the 110 V AC voltage available in a common house), the supply voltage shall be stepped down and rectified before being supplied to drive the image capturing device 15. The voltage regulating device 33 plays such a role to regulate the first voltage and the second voltage, so that the illuminating device 13 and the image capturing device 15 are adapted to be driven by a single power supply.

According to the abovementioned disclosures, by integrating the illuminating, sensing, image recording, sounding, and networking functions therein, the remote monitoring device of this invention can monitor the state of the surroundings in an active manner, thus significantly reducing the amount of image data amount and improving the reference value thereof.

The above disclosure is related to the detailed technical contents and inventive features thereof. People skilled in this field may proceed with a variety of modifications and replacements based on the disclosures and suggestions of the invention as described without departing from the characteristics thereof, for example, the illuminating device, the image capturing device, the loudspeaker, and the storage device may either be disposed separately from the body or integrated with the body. Nevertheless, although such modifications and replacements are not fully disclosed in the above descriptions, they have substantially been covered in the following claims as appended.

What is claimed is:

1. A monitoring device comprising:
a body;
an illuminating device for providing an indicating light source;
an image capturing device for capturing an image and generating an image signal;
a sensing device electrically connecting with the illuminating device and the image capturing device;
a loudspeaker electrically connecting with the sensing device;
wherein the illuminating device and the image capturing device are actuated to generate the image signal and the loudspeaker is actuated to sound when the sensing device senses that a state surrounding the monitoring device being different.

2. The monitoring device as claimed in claim 1, wherein the illuminating device includes at least one lamp being disposed on the body.

3. The monitoring device as claimed in claim 1, wherein the image capturing device is a visitor camera being disposed on the body.

4. The monitoring device as claimed in claim 1, further comprising a storage device being disposed in the body and adapted to store the image signal.

5. The monitoring device as claimed in claim 4, wherein the storage device comprises a storage medium.

6. The monitoring device as claimed in claim 5, wherein the storage medium comprises an SD (secure digital memory) card, a Mini SD card, a Micro SD card, a CF (compact flash) card, or a hard disk.

7. The monitoring device as claimed in claim 1, further comprising a network device being disposed on the body to transmit the image signal to a designated network.

8. The monitoring device as claimed in claim 7, wherein the designated network is an internet or a local area network.

9. The monitoring device as claimed in claim 7, wherein the network device transmits the image signal wirelessly.

10. The monitoring device as claimed in claim 1, wherein the sensing device includes a motion sensor which is adapted to sense the different state surrounding the monitoring device.

11. The monitoring device as claimed in claim 7, further comprising an audio receiving/transmitting device connecting with the network device for transmitting and receiving an audio signal with the designated network so that an user is adapted to monitor the state surrounding the monitoring device and remotely send/receive a sound.

12. The monitoring device as claimed in claim 11, wherein the audio receiving/transmitting device has an audio transmitting component performed by the loudspeaker.

13. The monitoring device as claimed in claim 1, further comprising an adjustment mechanism being disposed between the body and the image capturing device to adjust an image capturing angle of the image capturing device.

14. The monitoring device as claimed in claim 1, further comprising a voltage regulating device being disposed between the illuminating device and the image capturing device wherein the illuminating device is driven by a first voltage and the image capturing device is driven by a second voltage in which the voltage regulating device regulates the first voltage and the second voltage so that the illuminating device and the image capturing device are adapted to be driven by a power supply.

15. The monitoring device as claimed in claim 3, wherein the visitor camera is adapted to capture at least five image signals per second.

16. The monitoring device as claimed in claim 1, further comprising an automatic timer switch being disposed on the body and connecting with the illuminating device and the image capturing device for controlling the illuminating device and the image capturing device work within a desired period of time.
